(19) United States
(12) Patent Application Publication
(10) Pub. No.: US 2014/0149521 A1
(43) Pub. Date: May 29, 2014

(54) USING EXTENSIONS TO ROUTE COMMUNICATIONS IN A VIRTUAL ENVIRONMENT

(71) Applicant: INTERNATIONAL BUSINESS MACHINES CORP, Armonk, NY (US)

(72) Inventors: Michal Broz, Austin, TX (US); Bernadette A. Carter, Raleigh, NC (US); Melba I. Lopez, Raleigh, NC (US); Matthew G. Marum, Cary, NC (US)

(73) Assignee: INTERNATIONAL BUSINESS MACHINES CORPORATION, Armonk, NY (US)

(21) Appl. No.: 13/688,504

(22) Filed: Nov. 29, 2012

(51) Int. Cl. H04L 12/56

(52) U.S. Cl. CPC H04L 45/44
USPC 709/206; 709/238

(57) ABSTRACT

Routing incoming communications in a data processing system is provided. In response to receiving a current incoming communication to a communication address associated with the data processing system, it is determined whether an extension is associated with the current incoming communication. In response to determining that an extension is associated with the current incoming communication, the extension associated with the current incoming communication is determined to match an extension in a list of extensions corresponding to a plurality of profiles in the data processing system. Then, the current incoming communication is routed to a profile in the plurality of profiles that corresponds to the extension associated with the current incoming communication.

### BACKGROUND

1. Field

The disclosure relates generally to routing incoming communications and more specifically to routing incoming communications in a partitioned virtual environment of a data processing system using extensions.

2. Description of the Related Art

Today, mobile devices, such as smart phones, are being used by people in all aspects of their lives. For example, people are utilizing these mobile devices to manage their work life, social life, family life, and so on. As a result, these people are managing a myriad of calls, text messages, emails, contact lists, calendar entries, and other information on their mobile devices related to each of the different aspects of their lives. Consequently, these people are looking for ways to manage all of the information related to all of the different aspects of their lives.

### SUMMARY

According to one illustrative embodiment, a method for routing incoming communications in a data processing system. In response to the data processing system receiving a current incoming communication to a communication address associated with the data processing system, the data processing system determines whether an extension is associated with the current incoming communication. In response to the data processing system determining that an extension is associated with the current incoming communication, the data processing system determines that the extension associated with the current incoming communication matches an extension in a list of extensions corresponding to a plurality of profiles in the data processing system. Then, the data processing system routes the current incoming communication to a profile in the plurality of profiles that corresponds to the extension associated with the current incoming communication. According to other illustrative embodiments, a data processing system and a computer program product for routing incoming communications in a data processing system are provided.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a first type of mobile device in accordance with an illustrative embodiment;

FIG. 4 is a diagram illustrating an example of a second type of mobile device in accordance with an illustrative embodiment;

FIG. 5 is a diagram illustrating an example of routing incoming communications using a virtual machine manager in accordance with an illustrative embodiment;

FIG. 6 is a diagram illustrating an example of displayed profile screen shots in accordance with an illustrative embodiment;

FIG. 7 is a diagram illustrating an example of routing incoming communications using a profile manager in accordance with an illustrative embodiment;

FIG. 8 is a diagram illustrating an example of a displayed profile screen shot with a notification message in accordance with an illustrative embodiment;

FIG. 9 is a diagram illustrating an example of routing incoming communications without an extension in accordance with an illustrative embodiment; and

FIGS. 10A-10D are a flowchart illustrating a process for routing incoming communications in a virtual environment of a data processing system in accordance with an illustrative embodiment.

### DETAILED DESCRIPTION

As will be appreciated by one skilled in the art, aspects of the illustrative embodiments may be embodied as a data processing system, method, or computer program product. Accordingly, aspects of the illustrative embodiments may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the illustrative embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrative embodiments are described below with reference to flowchart illustrations and/or block diagrams of methods, data processing systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct computers, other programmable data processing systems, or other devices to function in a particular manner, such that the instructions stored in the computer readable medium produce an article of manufacture including instructions which implement the function/act specified in the flowchart and/or block diagram block or blocks.

The computer program instructions may also be loaded onto computers, other programmable data processing systems, or other devices to cause a series of operational steps to be performed on the computers, other programmable data processing systems, or other devices to produce a computer implemented process such that the instructions which execute on the computers or other programmable data processing systems provide processes for implementing the functions/acts specified in the flowchart and/or block diagram block or blocks.

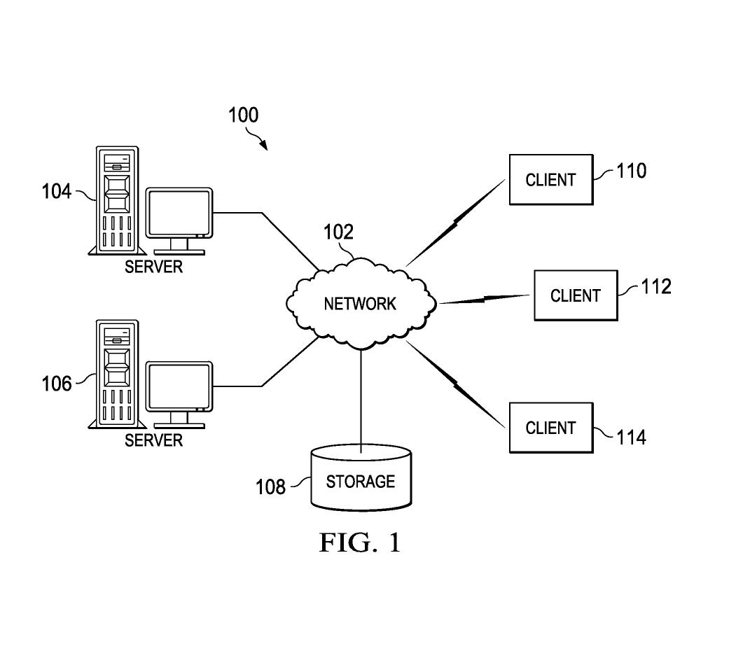

With reference now to the figures, and in particular, with reference to FIGS. 1-4, diagrams of data processing environments are provided in which illustrative embodiments may be implemented. It should be appreciated that FIGS. 1-4 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other devices in which the illustrative embodiments may be implemented. Network data processing system 100 contains network 102, which is the medium used to provide communications links between the computers and the other various devices connected together within network data processing system 100. Network 102 may include connections, such as wire, wireless communication links, or fiber optic cables.

In the depicted example, server 104 and server 106 connect to network 102, along with storage unit 108. Server 104 and server 106 may be, for example, server computers with high speed connections to network 102. In addition, server 104 and/or server 106 may provide communications services to a plurality of client devices connected to network 102. The communications services may be, for example, wireless telephone services, voice over internet protocol (VoIP) phone services, text messaging services, instant messaging services, short message service (SMS) messaging services, wireless fidelity (Wi-Fi) communication services, voice over wireless fidelity (VoWi-Fi) communication services, or any other type of communication services.

Clients 110, 112, and 114 also connect to network 102. Clients 110, 112, and 114 are clients to server 104 and/or server 106. In the depicted example, server 104 and/or server 106 may provide information, such as boot files, operating system images, and applications to clients 110, 112, and 114.

Clients 110, 112, and 114 may be, for example, mobile data processing systems, such as cellular telephones, smart phones, personal digital assistants, gaming devices, handheld computers, or any combination thereof, with wireless communication links to network 102. Clients 110, 112, and 114 may also include other types of data processing systems, such as personal computers, network computers, or portable computers, such as laptop computers.

Storage unit 108 is a network storage device capable of storing data in a structured or unstructured format. Storage unit 108 may provide, for example, storage of names and identification numbers of a plurality of users, user profiles corresponding to each of the plurality of users, and communication addresses, such as telephone numbers, e-mail addresses, text messaging addresses, and the like, for each user in the plurality of users. Furthermore, storage unit 108 may store other data, such as security information that may include user names, passwords, and/or biometric data associated with system administrators and other users of network data processing system 100.

Moreover, it should be noted that network data processing system 100 may include any number of additional server devices, client devices, and other devices not shown. Program code located in network data processing system 100 may be stored on a computer recordable storage medium and downloaded to a computer or other device for use. For example, program code may be stored on a computer recordable storage medium on server 106 and downloaded to client 114 over network 102 for use on client 114.

In the depicted example, network data processing system 100 may be implemented as a number of different types of networks, such as, for example, an intranet, a local area network (LAN), a wide area network (WAN), or an internet. Further, FIG. 1 is only intended as an example and not intended as an architectural limitation for the different illustrative embodiments.

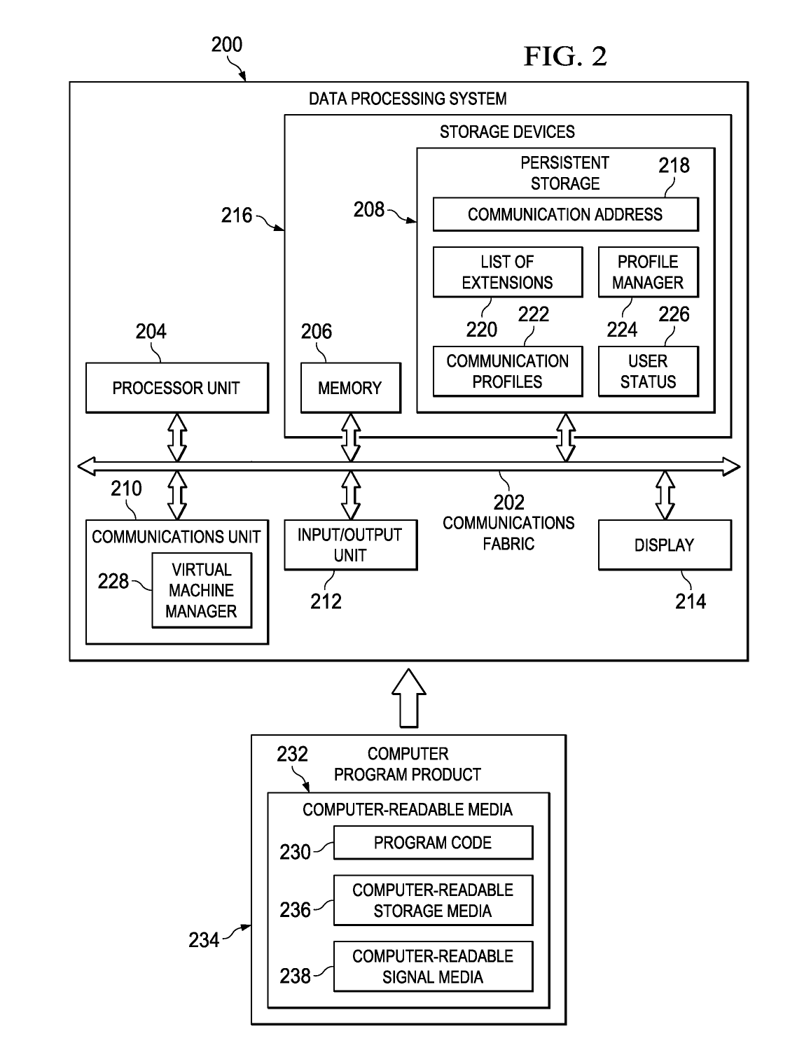

With reference now to FIG. 2, a diagram of a data processing system is depicted in accordance with an illustrative embodiment. Data processing system 200 is an example of a data processing system, such as server 104 or client 110 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications or programs that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type. Processor unit 204, along with memory 206 and persistent storage 208, may be utilized by a set of one or more virtual processors.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device does not include a non-statutory propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores communication address 218, list of extensions 220, communication profiles 222, profile manager 224, and user status 226. Communication address 218 is a network address that may include an alphanumeric sequence of characters, such as a telephone number, media access control (MAC) address, internet protocol address, an email address, instant messaging address, and the like, which other data processing system use to connect with and send communications to data processing system 200. In addition, communication address 218 may include a sequence of tones, voice inputs, or any combination of alphanumeric characters, tones, and voice inputs. The communications may be, for example, network communications, such as telephone calls, emails, text messages, instant messages, and the like.

List of extensions 220 lists a plurality of extensions. An extension is a set of one or more alphanumeric characters, special characters, symbols, tones, and/or voice inputs which users of other data processing systems add or append to the end of communication address 218 in order to route communications received by data processing system 200 to a particular communication profile in communication profiles 222. For example, a user of another data processing system may enter 123-456-7890 as communication address 218 of data processing system 200. Then, the user of the other data processing system may enter, for example, a pause or wait tone by depressing a pause or wait button on the user's data processing system, followed by entering an extension. The extension may be, for example, the number one, which routes the user's communication, such as a telephone call, to a particular communication profile, such as a friend communication profile, in data processing system 200. As another example, the user of the other data processing system may enter 123-456-7890 as communication address 218 and then add a voice input, such as the user's name, as the extension. As a result, data processing system 200 routes the incoming call to the appropriate communication profile based on the information obtained from the voice inputted extension (i.e., the user's name). For example, data processing system 200 may utilize voice recognition technology to convert the voice inputs to text and then analyze the text to determine which communication profile to route the incoming call to. It should be noted that each of the plurality of extensions listed in list of extensions 220 may correspond to one communication profile in communication profiles 222 or may correspond to a set of two or more communication profiles. In other words, an extension may route an incoming communication to more than one communication profile in communication profiles 222 depending on how the user defines the extension.

Communication profiles 222 may store a plurality of communication profiles, such as, for example, a work communication profile, a family communication profile, a friends communication profile, an entertainment communication profile, a social communication profile, and the like. A user of data processing system 200 may create whatever type of communication profile the user wants to store in communications profile 222. In addition, the user of data processing system 200 may create each communication profile to include, for example, unique backgrounds or wall papers, particular ring tones, chimes, alerts, graphics, pictures, banners, and different font sizes, styles, and colors. Alternatively, the user of data processing system 200 may select predefined screens or scenes for the communication profiles.

Profile manager 224 manages each of the communication profiles in communication profiles 222. For example, profile manager 224 determines whether communication address 218 of an incoming communication to data processing system 200 is associated with an extension. If communication address 218 is associated with an extension, then profile manager 224 matches the extension to one of the extensions listed in list of extensions 220. After matching the extension to an extension in list of extensions 220, then profile manager 224 selects a communication profile, which corresponds to the extension associated with communication address 218, from communication profiles 222 and displays the corresponding communication profile in display 214.

If communication address 218 is not associated with an extension, then profile manager 224 may determine, for example, characteristics of the incoming communication associated with communication address 218. Characteristics of the incoming communication may be, for example, a name of who sent the incoming communication to data processing system 200, a relationship between the sender of the incoming communication and the user of data processing system 200, the name of the sender being listed in a contact list of the user of data processing system 200, the communication address of the sending device, the geographic location of the sending device, the geographic location of the sending device in relation to data processing system 200, et cetera. After determining the characteristics associated with the incoming communication, profile manager 224 may select a communication profile that is most closely associated with the determined characteristics of the incoming communication. Alternative, profile manager 224 may select a communication profile from communication profiles 222 that the user of data processing system 200 designated as a default communication profile.

User status 226 lists a current status of the user of data processing system 200. The current status may be, for example, do not disturb, in a meeting, on vacation, on a business trip, currently communicating with another person in another communication profile, currently communicating with another person in the same communication profile, et cetera. Profile manager 224 may check user status 226 to determine whether to alert the user of data processing system 200 of an incoming communication corresponding to a particular communication profile.

Communications unit 210 provides for communication with other data processing systems or devices. Communications unit 210 may provide communications through the use of either or both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), or any other wireless communication technology or standard to establish a wireless communications link for data processing system 200. Communications unit 210 may be, for example, a subscriber identity module (SIM) card, a wireless fidelity card, a network interface card (NIC), or the like.

In an alternative illustrative embodiment, communications unit 210 may include virtual machine manager 228 instead of, or in addition to, profile manager 224. Virtual machine manager 228 may be, for example, a hypervisor. Data processing system 200 may utilize virtual machine manager 228 to manage a plurality of virtual machines or partitions in data processing system 200. Each of the plurality of virtual machines may include a guest operating system. Further, each of the plurality of virtual machines may include a different communication profile. Thus, virtual machine manager 228 may manage the different communication profiles located in each of the different virtual machines or partitions in data processing system 200 similar to the functionality of profile manager 224.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user. In addition, display 214 may include touch screen capabilities.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206. These instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 230 is located in a functional form on computer readable media 232 that is selectively removable and may be loaded onto or transferred to data processing system 200 for running by processor unit 204. Program code 230 and computer readable media 232 form computer program product 234. In one example, computer readable media 232 may be computer readable storage media 236 or computer readable signal media 238. Computer readable storage media 236 may include, for example, an optical or magnetic disc that is inserted or placed into a drive or other device that is part of persistent storage 208 for transfer onto a storage device, such as a hard drive, that is part of persistent storage 208. Computer readable storage media 236 also may take the form of a persistent storage, such as a hard drive, a thumb drive, or a flash memory that is connected to data processing system 200. In some instances, computer readable storage media 236 may not be removable from data processing system 200.

Alternatively, program code 230 may be transferred to data processing system 200 using computer readable signal media 238. Computer readable signal media 238 may be, for example, a propagated data signal containing program code 230. For example, computer readable signal media 238 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 230 may be downloaded over a network to persistent storage 208 from another device or data processing system through computer readable signal media 238 for use within data processing system 200. For instance, program code stored in a computer readable storage media in a server data processing system may be downloaded over a network from the server to data processing system 200. The data processing system providing program code 230 may be a server computer, a client computer, or some other device capable of storing and transmitting program code 230.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 236 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In the course of developing illustrative embodiments, it was discovered that virtualization is becoming increasingly popular on computers. A computer may run several instances of the same or different operating systems by providing each operating system instance with a virtual machine or a virtual set of hardware resources managed by an underlying software layer. However, virtualization on mobile data processing devices is not widely practiced or fully understood.

Illustrative embodiments provide consumers with a mobile phone having one base phone number that is associated with multiple extensions. Illustrative embodiments manage the base phone number of the mobile phone by using, for example, a virtual machine manager, such as a hypervisor, which routes incoming communications to an appropriate virtual machine in the mobile phone. This virtualization of the mobile phone allows a user to create however many virtual phone environments in the mobile phone as the user wants, simply by adding an extension to the base phone number associated with the mobile phone. The virtual machine manager maps the extension, which is appended to the end of the base phone number, to a virtual machine that corresponds to the extension. Also, it should be noted that the user may edit or delete any created virtual environment and/or its extension properties at any time.

Furthermore, if the mobile phone receives a telephone call without an extension being added to the base phone number, then the virtual machine manager determines which virtual machine most closely matches the incoming call based on characteristics of the incoming call. The characteristics of the incoming call may be determined using data associated with the incoming call, such as, for example, name and telephone number of the calling party using caller identification technology. In addition, illustrative embodiments may search for other data corresponding to the calling party on one or more networks and/or web sites, such as business networks and/or social media web sites. Further, illustrative embodiments may determine a geographic location of a calling party by using global positioning system (GPS) coordinates of the calling party's phone.

It should be noted that even though a mobile phone with a virtual machine manager is used in the examples, illustrative embodiments are not limited to mobile phones. In other words, illustrative embodiments may be implemented in other types of data processing systems, such as, for example, tablet computers, desktop computers, personal computers, network computers, laptop computers, handheld computers, or any other type of data processing device that may or may not be virtualized.

Also, it should be noted that illustrative embodiments may utilize two different types of virtual machine managers. A first type of virtual machine manager is directly run on the host mobile phone's hardware to control the hardware and manage guest operating systems associated with each of the different virtual machines of the host mobile phone. A guest operating system runs on another software level above the virtual machine manager. This first type of virtual machine manager represents a classic implementation of virtual machine architectures in data processing systems. A second type of virtual machine manager runs within a native operating system environment of the host mobile phone. With the virtual machine manager running as a distinct second software level above the host mobile phone's native operating system, guest operating systems run at a third software level above the hardware.

A base phone number, such as 123-456-7890, is stored on, for example, a hardware communications device of the mobile phone. The hardware communication device may be, for example, a subscriber identity module card, a wireless fidelity card, a network interface card, or the like. The virtual machine manager routes the incoming phone call to an appropriate virtual machine depending on the extension appended to the end of the base phone number of the mobile phone. The extension may be any set of one or more numbers and/or characters that follow the base phone number. For example, using the base phone number of 123-456-7890, the user may associate an extension of “1” to a friend's virtual machine, an extension of “2” to a work virtual machine, an extension of “3” to a family virtual machine, et cetera. As a result, when a caller dials 123-456-7890 and adds an extension of “1”, the virtual machine manager routes the incoming call to the friend's virtual machine that corresponds to extension “1”. It should be noted that illustrative embodiments may utilize a universal “wait” or “pause” tone to separate the base phone number from the extension. Also, if a particular virtual machine is not active (i.e., the virtual machine is in a standby mode or sleep mode, for example), then illustrative embodiments may utilize a type of wake up feature to activate the virtual machine.

Furthermore, profiles provide users with an ability to have multiple environments with different settings, such as backgrounds, fonts, et cetera, on a single mobile device. Moreover, illustrative embodiments enhance the profiles by adding an extra communication access point to each of the profiles. As an example, a user creates three different communication profiles: 1) a social communication profile for friends on one or more social media web sites; 2) an entertainment communication profile for “artsy” friends that enjoy movies, art, theater, opera, et cetera; and 3) a work communication profile for fellow employees and/or customers that the user communicates with. In addition, the user associates each communication profile with a particular communication access point (i.e., an extension). For example, the user may associate the social communication profile with 123-456-7890p1; the entertainment communication profile with 123-456-7890p2; and the work communication profile with 123-456-7890p3. It should be noted that “p” represents a pause tone, which separates the base phone number from the extension.

Further it should be noted that the base phone number 123-456-7890 may be used to receive, for example, phone calls, text messages, voice over internet protocol calls, et cetera. The profile manager may select an appropriate communication profile based on the incoming communication. For example, the profile manager may route an incoming communication, such as a text message, to an appropriate communication profile depending on the extension appended to base phone number 123-456-7890. As an example, the user of the mobile phone may be currently engaged in a telephone conversation in the user's work communication profile. Concurrently, the user receives a text message in the user's social communication profile. The user may set a user status, for example, to notify in the event of a new incoming communication. If the user sets the user status to notify, then the profile manager may display a notification message in the currently displayed communication profile (i.e., the work communication profile) notifying the user of an incoming text message in the social communication profile. The notification prevents the user from being diverted from what the user is currently doing.

Also, the user may assign different priority level values to each of the user's communication profiles. For example, regardless of which communication profile the user is currently in, the user may have set the work communication profile to take priority over all other communication profiles. As a result, the profile manager will automatically switch over from any other communication profile to the work communication profile in the event the mobile phone receives an incoming call, text, et cetera, in the work communication profile.

Thus, illustrative embodiments of the present invention provide a method, data processing system, and computer program product for routing incoming communications in a data processing system. In response to the data processing system receiving a current incoming communication to a communication address associated with the data processing system, the data processing system determines whether an extension is associated with the current incoming communication. In response to the data processing system determining that an extension is associated with the current incoming communication, the data processing system determines that the extension associated with the current incoming communication matches an extension in a list of extensions corresponding to a plurality of profiles in the data processing system. Then, the data processing system routes the current incoming communication to a profile in the plurality of profiles that corresponds to the extension associated with the current incoming communication.

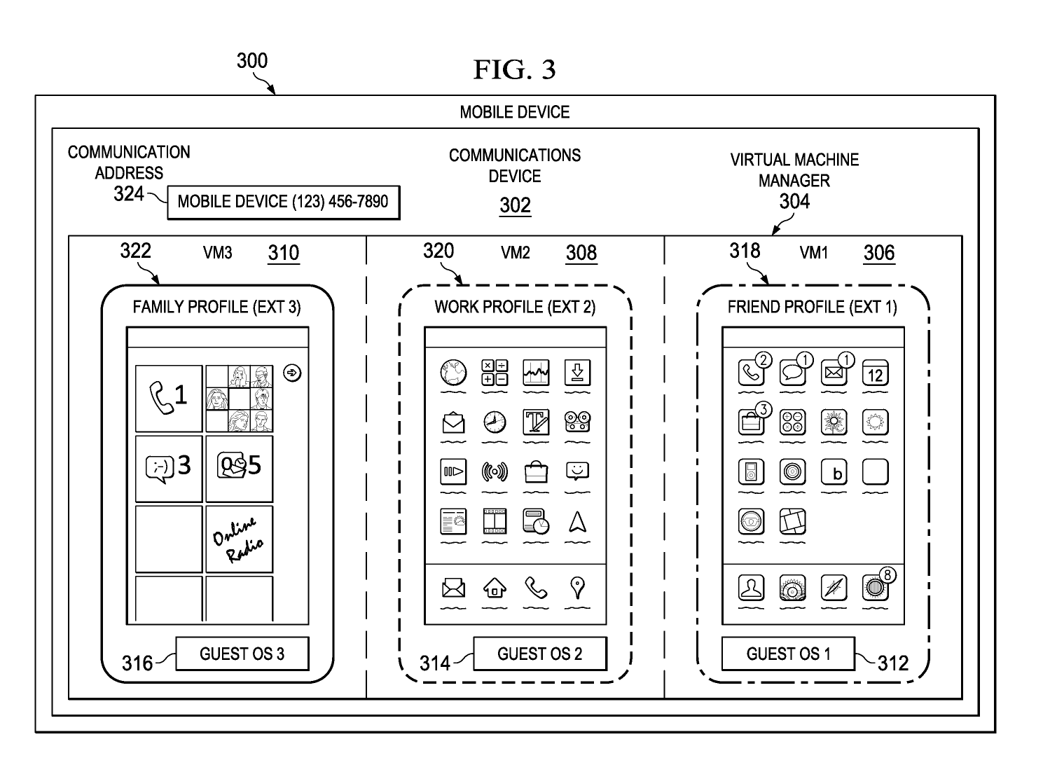

With reference now to FIG. 3, a diagram illustrating an example of a first type of mobile device is depicted in accordance with an illustrative embodiment. Mobile device 300 may be, for example, client 110 in FIG. 1. Also, mobile device 300 may be implemented in data processing system 200 in FIG. 2.

Mobile device 300 is an example of a mobile phone and includes communications device 302. Communications device 302 may be, for example, communications device 210 in FIG. 2. In this example, communications device 302 is a subscriber identify module card. Also in this example, communications device 302 includes virtual machine manager 304, such as virtual machine manager 228 in FIG. 2. In other words, virtual machine manager 304 runs on the hardware of communications device 302 and is an example of the first type of virtual machine manager discussed above.

Virtual machine manager 304 manages virtual machine (VM) 1 306, virtual machine 2 308, and virtual machine 3 310. However, it should be noted that even though in this illustrative example mobile device 300 includes three virtual machines, illustrative embodiments are not limited to such. In other words, mobile device 300 may include any number of virtual machines.

Virtual machine 1 306, virtual machine 2 308, and virtual machine 3 310 include guest operating system (OS) 1 312, guest operating system 2 314, and guest operating system 3 316, respectively. Guest operating system 1 312, guest operating system 2 314, and guest operating system 3 316 may be of the same type of operating system or different types of operating systems. In addition, guest operating system 1 312, guest operating system 2 314, and guest operating system 3 316 may be, for example, mobile phone operating systems that function independently of each other. Also, virtual machine 1 306 corresponds to friend profile (extension 1) 318, virtual machine 2 308 corresponds to work profile (extension 2) 320, and virtual machine 3 310 corresponds to family profile (extension 3) 322.

Further, mobile device 300 is associated with communication address 324. In this illustrative example, communication address 324 is a telephone number, such as (123) 456-7890, and is stored in communications device 302. If a family member calls 123-456-7890p3 and connects to mobile device 300, then virtual machine manager 304 routes the incoming call to virtual machine 3 310, which corresponds to family profile (extension 3) 322. Similarly, if a customer calls 123-456-7890p2 and connects to mobile device 300, then virtual machine manager 304 routes the incoming call to virtual machine 2 308, which corresponds to work profile (extension 2) 320. In the same way, if a friend calls 123-456-7890p1 and connects to mobile device 300, then virtual machine manager 304 routes the incoming call to virtual machine 1 306, which corresponds to friend profile (extension 1) 318.

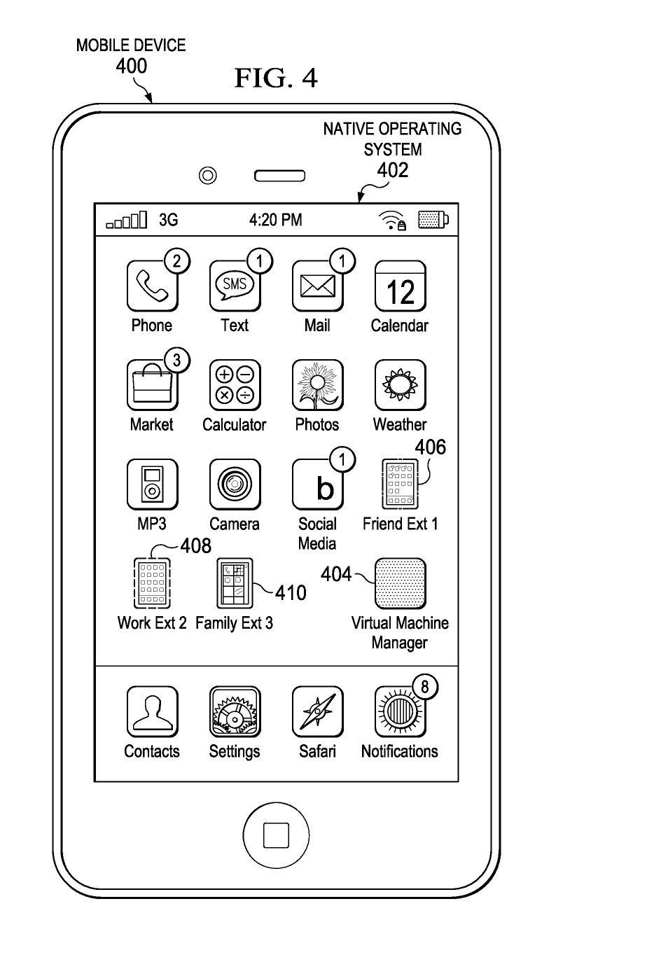

With reference now to FIG. 4, a diagram illustrating an example of a second type of mobile device is depicted in accordance with an illustrative embodiment. Mobile device 400 may be, for example, client 112 in FIG. 1. Also, mobile device 300 may be implemented in data processing system 200 in FIG. 2.

Mobile device 400 is an example of a mobile phone and includes native operating system 402. Native operating system 402 represents an operating system that was installed on mobile device 400. Native operating system 402 manages the software applications and hardware components of mobile device 400. In this example, native operating system 402 includes virtual machine manager 404. In other words, virtual machine manager 404 runs on native operating system 402 and is an example of the second type of virtual machine manager discussed above.

Virtual machine manager 404 manages virtual machines that correspond to friends profile extension 1 406, work profile extension 2 408, and family profile extension 3 410. The virtual machines that correspond to the different profiles may be, for example, virtual machine 1 306, virtual machine 2 308, and virtual machine 3 310 in FIG. 3. Each of the different virtual environments is seen as an application within native operating system 402 and is dependent on native operating system 402.

When a family member calls and connects to mobile device 400, virtual machine manager 404 routes the incoming call to the virtual machine that corresponds to family profile extension 3 410. Similarly, when a customer calls and connects to mobile device 400, virtual machine manager 404 routes the incoming call to the virtual machine that corresponds to work profile extension 2 408. In the same way, when a friend calls and connects to mobile device 400, then virtual machine manager 404 routes the incoming call to the virtual machine that corresponds to friends profile extension 1 406.

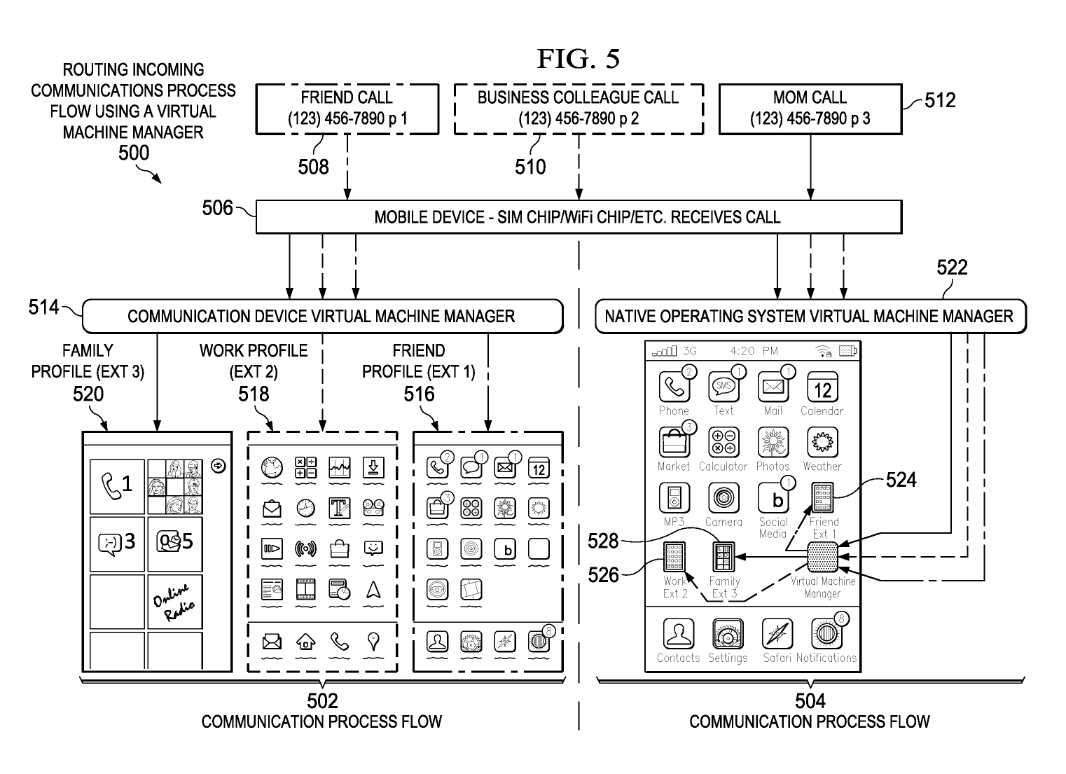

With reference now to FIG. 5, a diagram illustrating an example of routing incoming communications using a virtual machine manager is depicted in accordance with an illustrative embodiment. Routing incoming communications process flow using a virtual machine manager 500 may be implemented in a network of data processing system, such as network data processing system 100 in FIG. 1. Routing incoming communications process flow using a virtual machine manager 500 includes communication process flow 502 and communication process flow 504.

Communication process flow 502 is a communication process flow associated with the first type of virtual machine manager shown in FIG. 3. Communication process flow 502 begins when mobile device 506 receives incoming communications. For example, when a friend calls (123) 456-7890p1 508 and connects to mobile device 506, communication device virtual machine manager 514 routes the incoming call to the virtual machine that corresponds to friend profile extension 1 516. It should be noted that the “p” between the base phone number and the extension represents a pause tone in the communication address. Also, communication device virtual machine manager 514 may be, for example, virtual machine manager 304 located in communications device 302 in FIG. 3. Similarly, when a business colleague calls (123) 456-7890p2 510 and connects to mobile device 506, communication device virtual machine manager 514 routes the incoming call to the virtual machine that corresponds to work profile extension 2 518. In the same way, when the user's mother calls (123) 456-7890p3 512 and connects to mobile device 506, communication device virtual machine manager 514 routes the incoming call to the virtual machine that corresponds to family profile extension 3 520.

Communication process flow 504 is a communication process flow associated with the second type of virtual machine manager shown in FIG. 4. Communication process flow 504 begins when mobile device 506 receives incoming communications. For example, when a friend calls (123) 456-7890p1 and connects to mobile device 506, then native operating system virtual machine manager 522 routes the incoming call to the virtual machine that corresponds to friends profile extension 1 524. Native operating system virtual machine manager 522 may be, for example, virtual machine manager 404 located in native operating system 402 in FIG. 4. Similarly, when a business colleague calls (123) 456-7890p2 and connects to mobile device 506, native operating system virtual machine manager 522 routes the incoming call to the virtual machine that corresponds to work profile extension 2 526. In the same way, when the user's mother calls (123) 456-7890p3 and connects to mobile device 506, native operating system virtual machine manager 522 routes the incoming call to the virtual machine that corresponds to family profile extension 3 528.

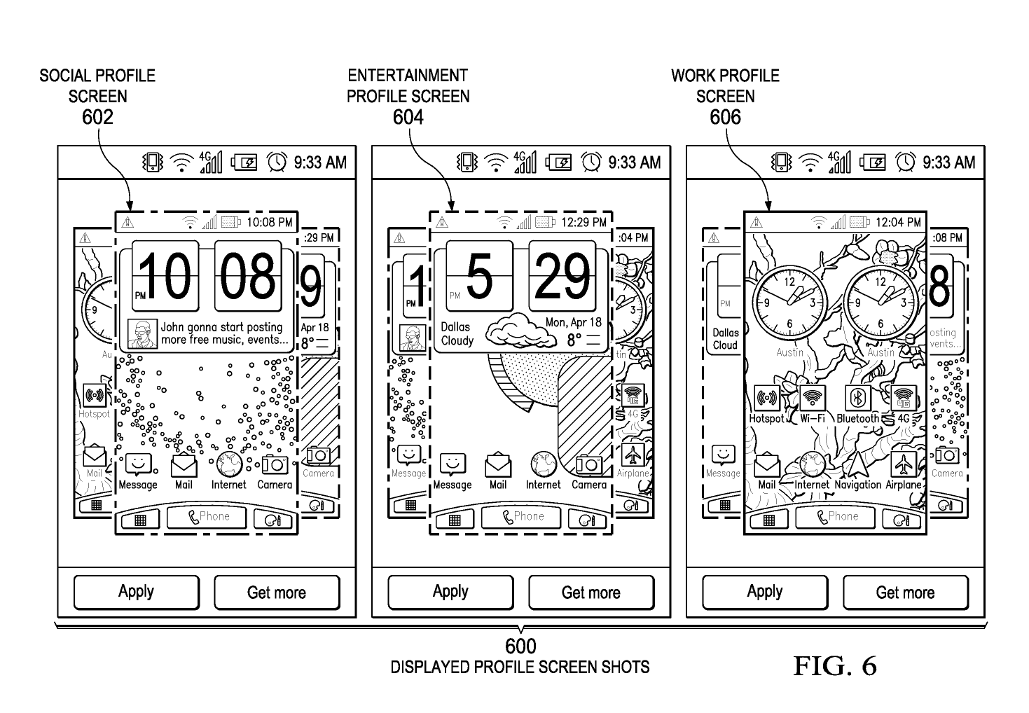

With reference now to FIG. 6, a diagram illustrating an example of displayed profile screen shots is depicted in accordance with an illustrative embodiment. Displayed profile screen shots 600 are examples of profile screens that illustrative embodiments may display to a user on a display device, such as display 214 in FIG. 2. Displayed profile screen shots 600 include social profile screen 602, entertainment profile screen 604, and work profile screen 606. However, it should be noted that illustrative embodiments also may include other types of profile screens, such as a friends profile screen, a family profile screen, or any other type of screen for other types of profiles that a user may create.

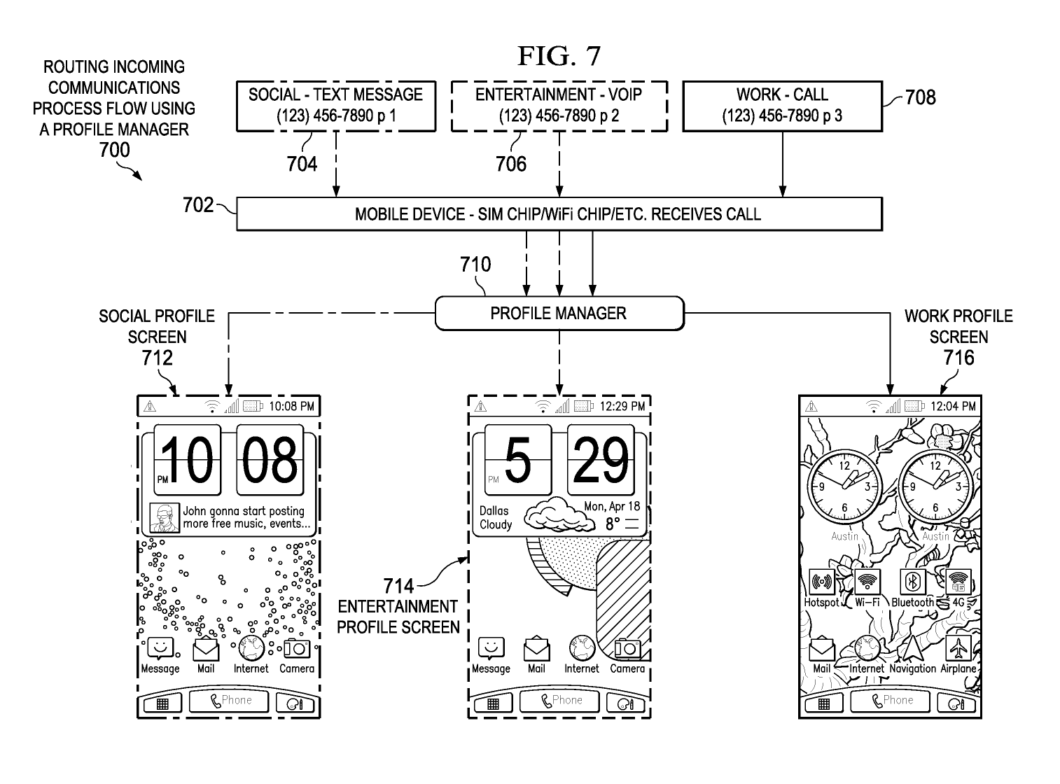

With reference now to FIG. 7, a diagram illustrating an example of routing incoming communications using a profile manager is depicted in accordance with an illustrative embodiment. Routing incoming communications process flow using a profile manager 700 may be implemented in a network of data processing system, such as network data processing system 100 in FIG. 1.

The communication process flow begins when mobile device 702 receives incoming communications. For example, when a social contact sends a text message to communication address (123) 456-7890p1 704 associated with mobile device 702, profile manager 710 routes the incoming text message to a social profile corresponding to extension 1 and displays the incoming text message in social profile screen 712. Profile manager 710 may be, for example, profile manager 224 in FIG. 2. Similarly, when an entertainment contact makes a voice over internet protocol call to communication address (123) 456-7890p2 706, profile manager 710 routes the incoming voice over internet protocol call to the virtual machine that corresponds to an entertainment profile corresponding to extension 2 and displays an indication of the incoming voice over internet protocol call in entertainment profile screen 714. In the same way, when a work contact calls communication address (123) 456-7890p3 708, profile manager 710 routes the incoming call to a work profile corresponding to extension 3 and displays an indication of the incoming call in work profile screen 716.

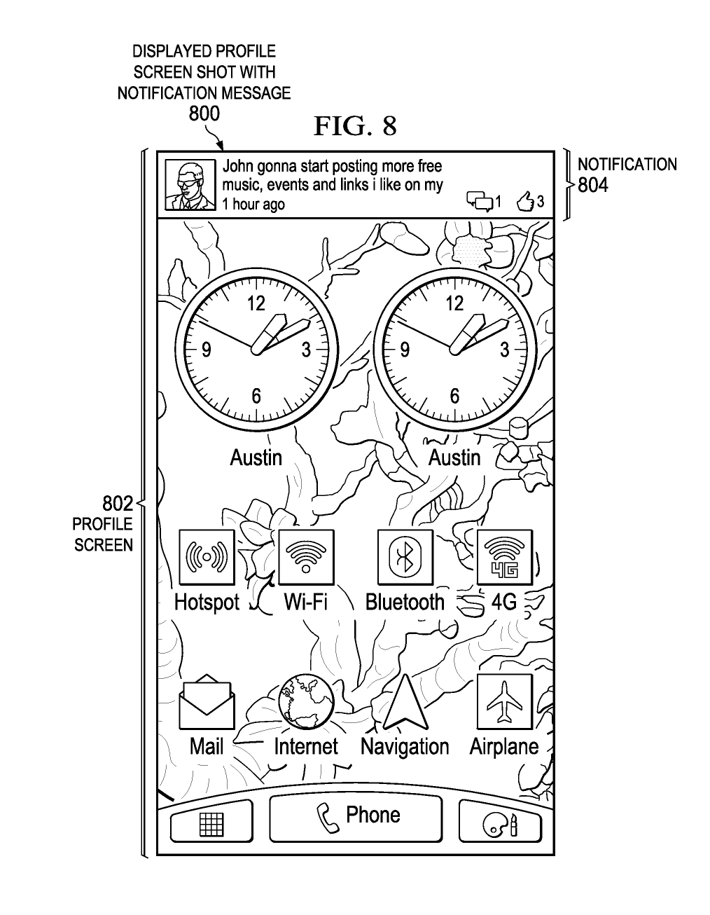

With reference now to FIG. 8, a diagram illustrating an example of a displayed profile screen shot with a notification message is depicted in accordance with an illustrative embodiment. Displayed profile screen shot with notification message 800 includes profile screen 802 and notification 804. Profile screen 802 may be, for example, work profile screen 716 in FIG. 7. Notification 804 is a message banner at the top of profile screen 802 alerting a user of an incoming communication. In this example, the incoming communication is a text message from a friend. Also, it should be noted that even though notification 804 is shown at the top of profile screen 802 as a message banner, illustrative embodiments are not limited to such. In other words, illustrative embodiments may locate notification 804 anywhere on profile screen 802 and in any manner.

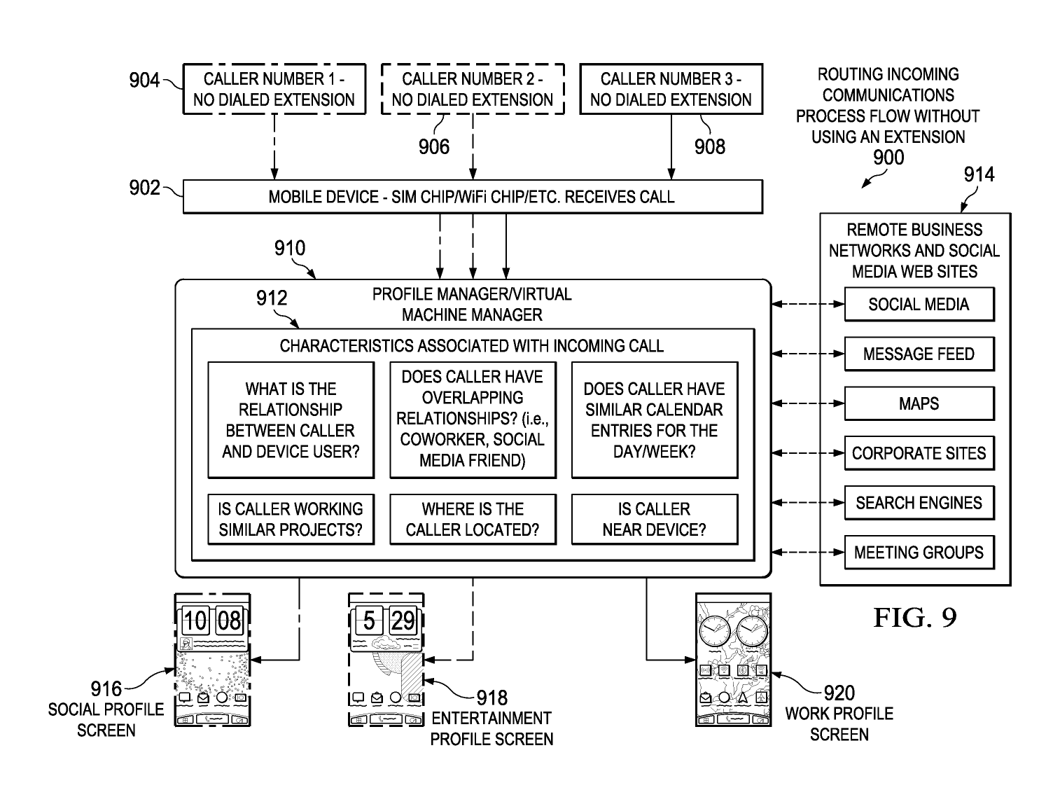

With reference now to FIG. 9, a diagram illustrating an example of routing incoming communications without an extension is depicted in accordance with an illustrative embodiment. Routing incoming communications process flow without using an extension 900 may be implemented in a network of data processing system, such as network data processing system 100 in FIG. 1.

In general if a caller does not provide an extension with a call, then depending on which illustrative embodiment is implemented in mobile device 902 either a profile manager, a virtual machine manager, or a software application that performs the same functions will determine characteristics associated with the call based on known data, such as the caller's name and telephone number using caller identification technology. The profile manager may be, for example, profile manager 224 in FIG. 2. The virtual machine manager may be, for example, virtual machine manager 228 in FIG. 2. The profile manager or virtual machine manager may then perform a search on one or more networks for other characteristics associated with the call, such as a location of the caller's device, social media profile data associated with the caller, et cetera.

If the profile manager or the virtual machine manager is able to retrieve the other characteristics associated with the call within a predetermined period of time and the caller still has not entered an extension, then the profile manager or virtual machine manager compares all the determined characteristics associated with the call to profiles stored in the mobile device. The profiles may be, for example, communication profiles 222 in FIG. 2. If the profile manager or the virtual machine manager is able to determine a close match between the determined characteristics associated with the call and a communication profile, then the profile manager or virtual machine manager routes the call to the closest matching communication profile.

For example, when Caller #1, who is a message feed and social media friend, calls mobile device 902 with no dialed extension 904, profile manager/virtual machine manager 910 determines characteristics associated with the incoming call, such as characteristics associated with incoming call 912. Characteristics associated with incoming call 912 may be determined by searching remote business networks and social media web sites 914. By searching remote business networks and social media web sites 914, profile manager/virtual machine manager 910 determines that the caller does not work in the same company as the user, but the caller is geographically located around the same area as mobile device 902. As a result, profile manager/virtual machine manager 910 determines that the caller is calling for socially-related reasons based on the caller and user not being coworkers and the caller being located near the user. Consequently, profile manager/virtual machine manager 910 routes call with no dialed extension 904 to social profile screen 916.

When Caller #2, who is a message feed, social media, meeting group, and search engine friend and who is a coworker, calls mobile device 902 with no dialed extension 906, profile manager/virtual machine manager 910 determines characteristics associated with incoming call 912. By searching remote business networks and social media web sites 914, profile manager/virtual machine manager 910 determines that the caller and the user are working on the same project and have similar meeting calendar entries. In addition, profile manager/virtual machine manager 910 determines that the caller is located on the west coast in a different time zone. As a result, profile manager/virtual machine manager 910 determines that the caller is calling for work-related reasons based on the caller and the user working on the same project and having similar meeting calendar entries. Consequently, profile manager/virtual machine manager 910 routes call with no dialed extension 906 to work profile screen 920.

When Caller #3, who is a meeting group friend and a coworker, calls mobile device 902 with no dialed extension 908, profile manager/virtual machine manager 910 determines characteristics associated with incoming call 912. By searching remote business networks and social media web sites 914, profile manager/virtual machine manager 910 determines that the caller and the user are working on the same team and have similar meeting calendar entries. In addition, profile manager/virtual machine manager 910 determines that the caller is located near the user and that the time of the call coincides with a meeting group movie calendar event. As a result, profile manager/virtual machine manager 910 determines that the caller is calling for entertainment-related reasons based on the time of the call and the movie calendar entry. Consequently, profile manager/virtual machine manager 910 routes call with no dialed extension 908 to entertainment profile screen 918.

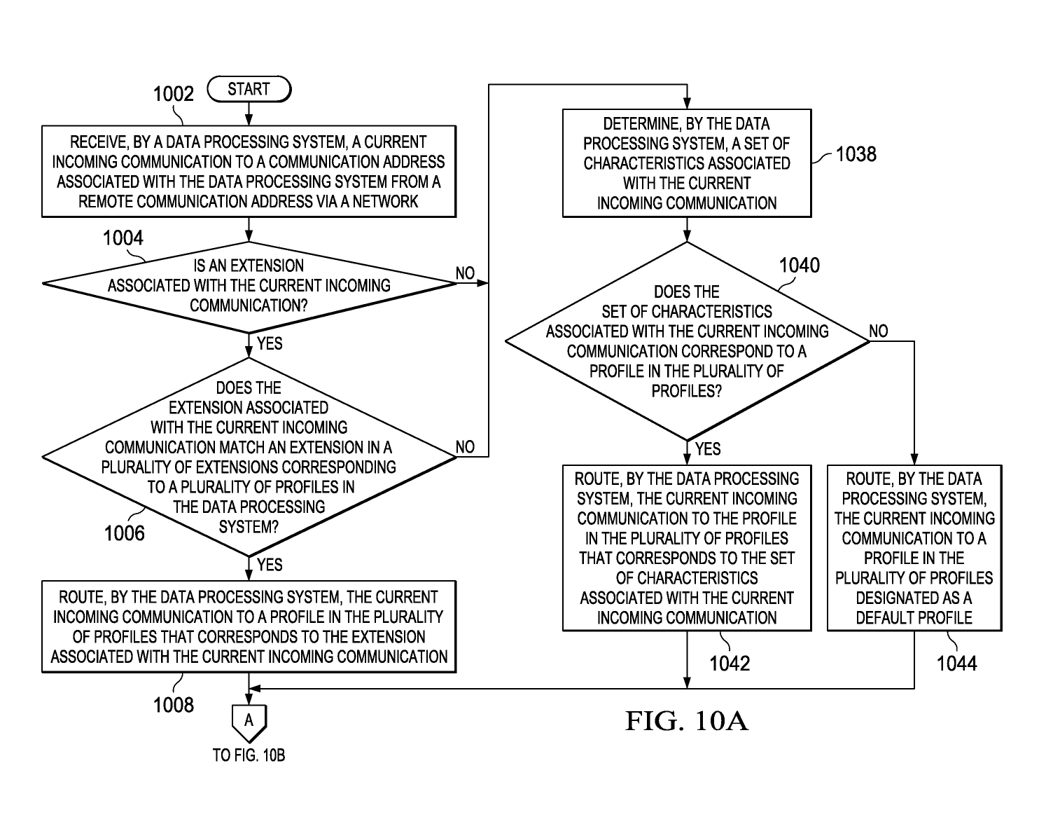

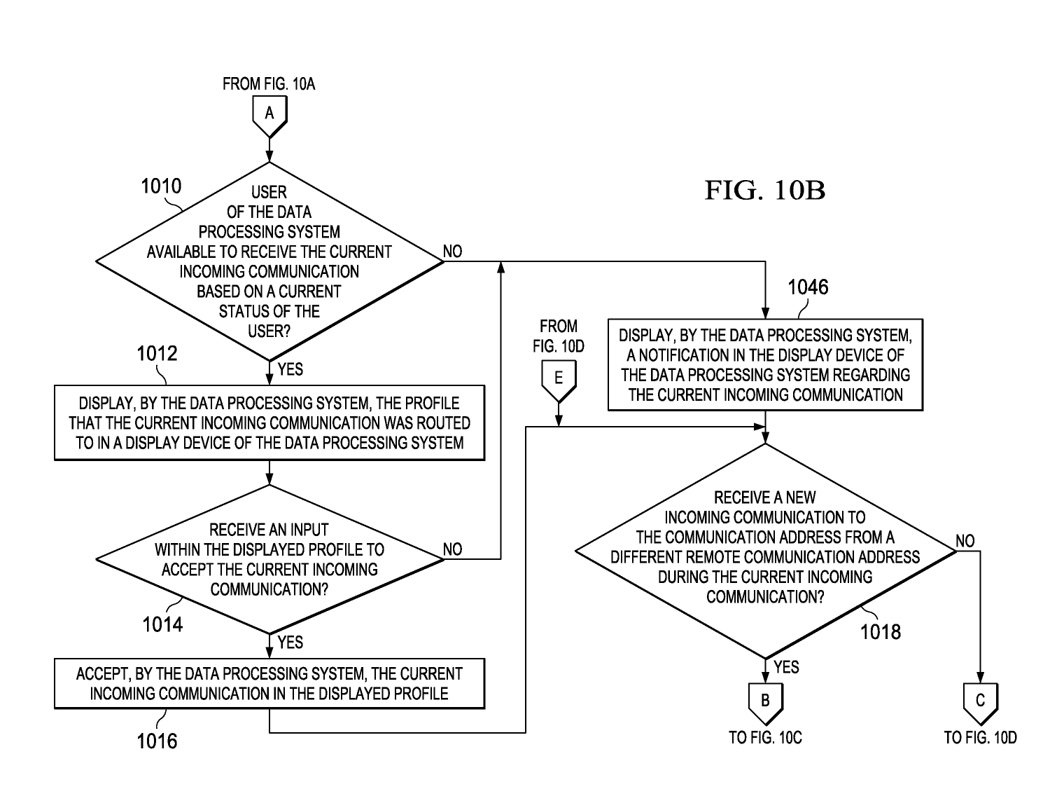

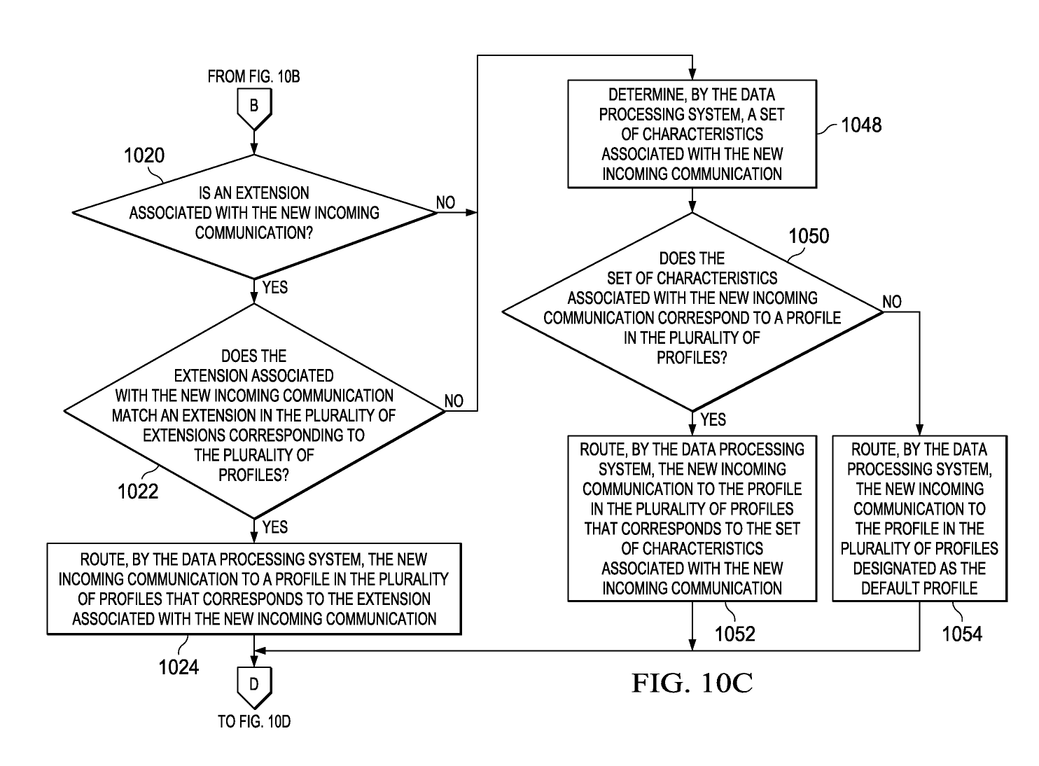

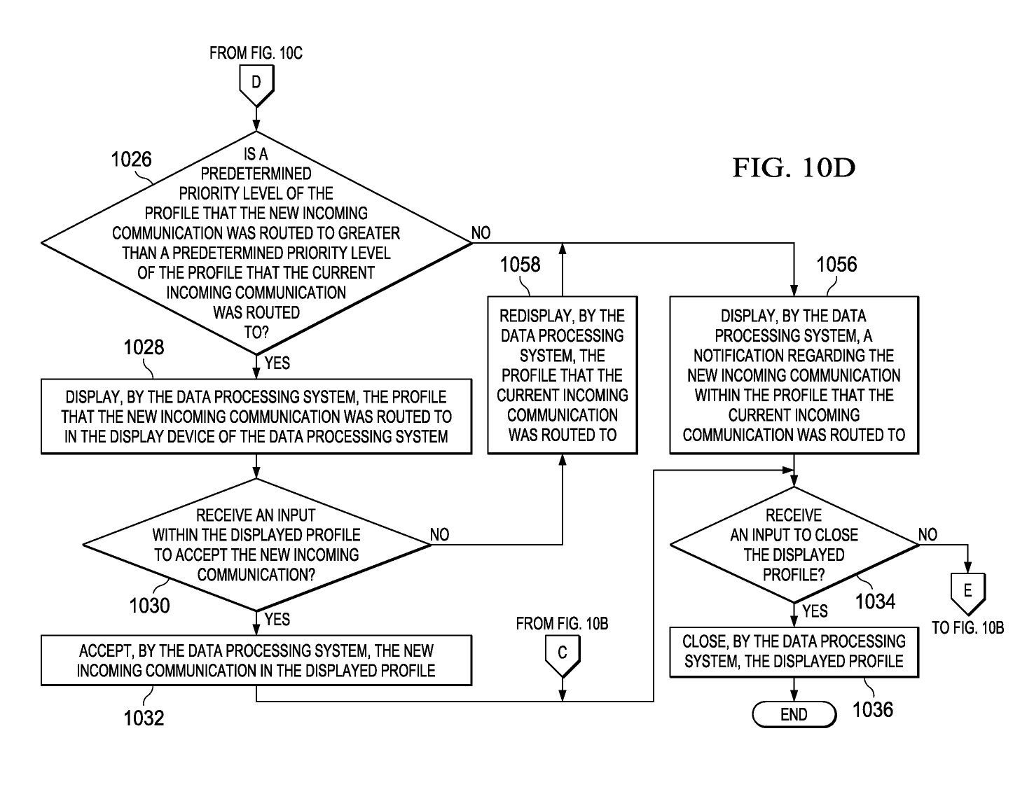

With reference now to FIGS. 10A-10D, a flowchart illustrating a process for routing incoming communications in a virtual environment of a data processing system is shown in accordance with an illustrative embodiment. The process shown in FIGS. 10A-10D may be implemented in a data processing system, such as, for example, data processing system 200 in FIG. 2.

The process begins when the data processing system receives a current incoming communication to a communication address associated with the data processing system from a remote communication address via a network (step 1002). The current incoming communication may be, for example, a network communication, such as a telephone call, an email, a text message, an instant message, and the like. The communication address associated with the data processing system may be, for example, communication address 324 associated with mobile device 300 in FIG. 3. The network may be, for example, network 102 in FIG. 1.

After receiving the current incoming communication in step 1002, the data processing system makes a determination as to whether an extension is associated with the current incoming communication (step 1004). The extension is a set of one or more alphanumeric characters, special characters, symbols, tones, and/or voice inputs that follows the communication address. In addition, the extension may be appended to the communication address or may be sent separately within a predetermined threshold period of time. The predetermined threshold period of time may be, for example, ten seconds after the data processing system receives the current incoming communication. However, it should be noted that the predetermined threshold period of time may be any increment of time.

If the data processing system determines that an extension is associated with the current incoming communication, yes output of step 1004, then the data processing system makes a determination as to whether the extension associated with the current incoming communication matches an extension in a plurality of extensions corresponding to a plurality of profiles in the data processing system (step 1006). The plurality of extensions corresponding to the plurality of profiles may be, for example, list of extensions 220 corresponding to communication profiles 222 in FIG. 2. If the data processing system determines that the extension associated with the current incoming communication does not match an extension in the plurality of extensions corresponding to the plurality of profiles in the data processing system, no output of step 1006, then the process proceeds to step 1038. If the data processing system determines that the extension associated with the current incoming communication does match an extension in the plurality of extensions corresponding to the plurality of profiles in the data processing system, yes output of step 1006, then the data processing system routes the current incoming communication to a profile in the plurality of profiles that corresponds to the extension associated with the current incoming communication (step 1008).

In addition, the data processing system makes a determination as to whether a user of the data processing system is available to receive the current incoming communication based on a current status of the user (step 1010). The current status of the user may be, for example, user status 226 in FIG. 2. The user may set the user's current status to, for example, do not disturb, in a meeting, notify upon receipt of an incoming communication, et cetera. In addition, the data processing system may automatically set the current status of the user based on, for example, entries in the user's electronic calendar, postings by the user on one or more social media web sites, or the data processing system determining that the user is already engaged in a telephone call.

If the data processing system determines that the user of the data processing system is available to receive the current incoming communication based on the current status of the user, yes output of step 1010, then the data processing system displays the profile that the current incoming communication was routed to in a display device of the data processing system (step 1012). The displayed profile may be, for example, work profile screen 606 in FIG. 6. Further, the data processing system makes a determination as to whether the data processing system received an input within the displayed profile to accept the current incoming communication (step 1014). If the data processing system determines that an input was not received within the displayed profile to accept the current incoming communication, no output of step 1014, then the process proceeds to step 1046. If the data processing system determines that an input was received within the displayed profile to accept the current incoming communication, yes output of step 1014, then the data processing system accepts the current incoming communication in the displayed profile (step 1016).

Subsequent to accepting the current incoming communication in the displayed profile in step 1016, then the data processing system makes a determination as to whether the data processing system received a new incoming communication to the communication address from a different remote communication address during the current incoming communication (step 1018). If the data processing system determines that a new incoming communication to the communication address was not received from a different remote communication address during the current incoming communication, no output of step 1018, then the process proceeds to step 1034. If the data processing system determines that a new incoming communication to the communication address was received from a different remote communication address during the current incoming communication, yes output of step 1018, then the data processing system makes a determination as to whether an extension is associated with the new incoming communication (step 1020).

If the data processing system determines that an extension is associated with the new incoming communication, yes output of step 1020, then the data processing system makes a determination as to whether the extension associated with the new incoming communication matches an extension in the plurality of extensions corresponding to the plurality of profiles (step 1022). If the data processing system determines that the extension associated with the new incoming communication does not match an extension in the plurality of extensions corresponding to the plurality of profiles, no output of step 1022, then the process proceeds to step 1048. If the data processing system determines that the extension associated with the new incoming communication does match an extension in the plurality of extensions corresponding to the plurality of profiles, yes output of step 1022, then the data processing system routes the new incoming communication to a profile in the plurality of profiles that corresponds to the extension associated with the new incoming communication (step 1024).

Further, the data processing system makes a determination as to whether a predetermined priority level of the profile that the new incoming communication was routed to is greater than a predetermined priority level of the profile that the current incoming communication was routed to (step 1026). The predetermined priority levels of the different profiles may be set by the user, for example. If the data processing system determines that the predetermined priority level of the profile that the new incoming communication was routed to is greater than the predetermined priority level of the profile that the current incoming communication was routed to, yes output of step 1026, then the data processing system displays the profile that the new incoming communication was routed to in the display device of the data processing system (step 1028).

In addition, the data processing system makes a determination as to whether the data processing system received an input within the displayed profile to accept the new incoming communication (step 1030). If the data processing system determines that an input was received within the displayed profile to accept the new incoming communication, yes output of step 1030, then the data processing system accepts the new incoming communication in the displayed profile (step 1032). Then, the data processing system makes a determination as to whether the data processing system received an input to close the displayed profile (step 1034). If the data processing system determines that an input was received to close the displayed profile, yes output of step 1034, then the data processing system closes the displayed profile (step 1036) and the process terminates thereafter. If the data processing system determines that an input was not received to close the displayed profile, no output of step 1034, then the process returns to step 1018 where the data processing system determines whether a new incoming communication to the communication address was received from a different remote communication address during the current incoming communication.

Returning again to step 1004, if the data processing system determines that an extension is not associated with the current incoming communication, no output of step 1004, then the data processing system determines a set of characteristics associated with the current incoming communication (step 1038). The set of characteristics associated with the current incoming communication may be, for example, a name and communication address of the sending party and a relationship of the sending party to the user of the data processing system. Afterward, the data processing system makes a determination as to whether the set of characteristics associated with the current incoming communication corresponds to a profile in the plurality of profiles (step 1040).

If data processing system determines that the set of characteristics associated with the current incoming communication does correspond to a profile in the plurality of profiles, yes output of step 1040, then the data processing system routes the current incoming communication to the profile in the plurality of profiles that corresponds to the set of characteristics associated with the current incoming communication (step 1042). Thereafter, the process returns to step 1010 where the data processing system determines whether the user of the data processing system is available to receive the current incoming communication based on the current status of the user. If data processing system determines that the set of characteristics associated with the current incoming communication does not correspond to a profile in the plurality of profiles, no output of step 1040, then the data processing system routes the current incoming communication to a profile in the plurality of profiles designated as a default profile (step 1044) and the process returns to step 1010 thereafter.

Returning again to step 1010, if the data processing system determines that the user of the data processing system is not available to receive the current incoming communication based on the current status of the user, no output of step 1010, then the data processing system displays a notification in the display device of the data processing system regarding the current incoming communication (step 1046). The notification may be, for example, notification 804 in FIG. 8. Thereafter, the process returns to step 1018 where the data processing system determines whether a new incoming communication to the communication address was received from a different remote communication address during the current incoming communication.

Returning now to step 1020, if the data processing system determines that the extension associated with the new incoming communication does not match an extension in the plurality of extensions corresponding to the plurality of profiles, no output of step 1022, then the data processing system determines a set of characteristics associated with the new incoming communication (step 1048). Further, the data processing system makes a determination as to whether the set of characteristics associated with the new incoming communication corresponds to a profile in the plurality of profiles (step 1050). If the data processing system determines that the set of characteristics associated with the new incoming communication does correspond to a profile in the plurality of profiles, yes output of step 1050, then the data processing system routes the new incoming communication to the profile in the plurality of profiles that corresponds to the set of characteristics associated with the new incoming communication (step 1052). Thereafter, the process returns to step 1026 where the data processing system determines whether the predetermined priority level of the profile that the new incoming communication was routed to is greater than the predetermined priority level of the profile that the current incoming communication was routed to. If the data processing system determines that the set of characteristics associated with the new incoming communication does not correspond to a profile in the plurality of profiles, no output of step 1050, then the data processing system routes the new incoming communication to the profile in the plurality of profiles designated as the default profile (step 1054) and the process returns to step 1026 thereafter.

Returning again to step 1026, if the data processing system determines that the predetermined priority level of the profile that the new incoming communication was routed to is not greater than the predetermined priority level of the profile that the current incoming communication was routed to, no output of step 1026, then the data processing system displays a notification regarding the new incoming communication within the profile that the current incoming communication was routed to (step 1056). Thereafter, the process returns to step 1034 where the data processing systems determines whether an input was received to close the displayed profile.

Returning again to step 1030, if the data processing system determines that an input was not received within the displayed profile to accept the new incoming communication, no output of step 1030, then the data processing system redisplays the profile that the current incoming communication was routed to (step 1058). Thereafter, the process returns to step 1056 where the data processing system displays a notification regarding the new incoming communication within the profile that the current incoming communication was routed to.

Thus, illustrative embodiments provide a method, a data processing system, and a computer program product for routing incoming communications in a partitioned virtual environment of a data processing system using a plurality of extensions. The descriptions of the various illustrative embodiments have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the figures illustrate the architecture, functionality, and operation of possible implementations of systems, methods, and computer program products according to various illustrative embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for routing incoming communications in a data processing system, the method comprising:
responsive to the data processing system receiving a current incoming communication to a communication address associated with the data processing system, determining, by the data processing system, whether an extension is associated with the current incoming communication;
responsive to the data processing system determining that an extension is associated with the current incoming communication, determining, by the data processing system, that the extension associated with the current incoming communication matches an extension in a list of extensions corresponding to a plurality of profiles in the data processing system; and
routing, by the data processing system, the current incoming communication to a profile in the plurality of profiles that corresponds to the extension associated with the current incoming communication.

2. The method of claim 1 further comprising:
responsive to the data processing system determining that an extension is not associated with the current incoming communication, determining, by the data processing system, a set of characteristics associated with the current incoming communication.

3. The method of claim 2, wherein the data processing system determines the set of characteristics associated with the current incoming communication by searching at least one of a set of business networks and a set of social media web sites.

4. The method of claim 2 further comprising:
determining, by the data processing system, whether the set of characteristics associated with the current incoming communication corresponds to a profile in the plurality of profiles; and
responsive to the data processing system determining that the set of characteristics associated with the current incoming communication does correspond to a profile in the plurality of profiles, routing, by the data processing system, the current incoming communication to the profile in the plurality of profiles that corresponds to the set of characteristics associated with the current incoming communication.

5. The method of claim 4 further comprising:
responsive to the data processing system determining that the set of characteristics associated with the current incoming communication does not correspond to a profile in the plurality of profiles, routing, by the data processing system, the current incoming communication to a profile in the plurality of profiles designated as a default profile.

6. The method of claim 1 further comprising:
determining, by the data processing system, whether a user of the data processing system is available to receive the current incoming communication based on a current status of the user; and
responsive to the data processing system determining that the user of the data processing system is available to receive the current incoming communication based on the current status of the user, displaying, by the data processing system, the profile that the current incoming communication was routed to in a display device of the data processing system.

7. The method of claim 6 further comprising:
responsive to the data processing system determining that the user of the data processing system is not available to receive the current incoming communication based on the current status of the user, displaying, by the data processing system, a notification in the display device of the data processing system regarding the current incoming communication.

8. The method of claim 1 further comprising:
responsive to the data processing system determining that a new incoming communication to the communication address was received during the current incoming communication, determining, by the data processing system, whether a predetermined priority level of a profile that the new incoming communication was routed to is greater than a predetermined priority level of the profile that the current incoming communication was routed to; and
responsive to the data processing system determining that the predetermined priority level of the profile that the new incoming communication was routed to is greater than the predetermined priority level of the profile that the current incoming communication was routed to, displaying, by the data processing system, the profile that the new incoming communication was routed to in a display device of the data processing system.

9. The method of claim 8 further comprising:
responsive to the data processing system determining that the predetermined priority level of the profile that the new incoming communication was routed to is not greater than the predetermined priority level of the profile that the current incoming communication was routed to, displaying, by the data processing system, a notification regarding the new incoming communication within the profile that the current incoming communication was routed to.

10. The method of claim 1, wherein the data processing system is one of a cellular telephone, a smart phone, a personal digital assistant, a gaming device, or a computer device.

11. The method of claim 1, wherein the current incoming communication is a network communication, and wherein the network communication is one of a telephone call, a text message, an instant message, an email message, or a voice over internet protocol call.

12. The method of claim 1, wherein the communication address is a network communication address, and wherein the network communication address is one of a telephone number, a media access control address, an internet protocol address, an email address, or an instant messaging address.

13. The method of claim 1, wherein the extension is at least one of a set of characters, a set of symbols, a set of tones, and a set of voice inputs appended to an end of the communication address in order to route the current incoming communication to a particular profile in the plurality of profiles.

14. The method of claim 1, wherein the data processing system includes a plurality of virtual machines corresponding to the plurality of profiles.

15. A data processing system for routing incoming communications, the data processing system comprising:
a bus system;
a storage device connected to the bus system, wherein the storage device stores computer readable program code; and
a processor unit connected to the bus system, wherein the processor unit executes the computer readable program code to determine whether an extension is associated with a current incoming communication to a communication address associated with the data processing system in response to receiving the current incoming communication; determine that the extension associated with the current incoming communication matches an extension in a list of extensions corresponding to a plurality of profiles in the data processing system in response to determining that an extension is associated with the current incoming communication; and route the current incoming communication to a profile in the plurality of profiles that corresponds to the extension associated with the current incoming communication.

16. The data processing system of claim 15, wherein the processor unit further executes the computer readable program code to determine a set of characteristics associated with the current incoming communication in response to determining that an extension is not associated with the current incoming communication.

17. A computer program product stored on a computer readable storage medium having computer readable program code embodied thereon that is executable by a data processing system for routing incoming communications within the data processing system, the computer program product comprising:
computer readable program code for determining whether an extension is associated with a current incoming communication to a communication address associated with the data processing system in response to receiving the current incoming communication;
computer readable program code for determining that the extension associated with the current incoming communication matches an extension in a list of extensions corresponding to a plurality of profiles in the data processing system in response to determining that an extension is associated with the current incoming communication; and
computer readable program code for routing the current incoming communication to a profile in the plurality of profiles that corresponds to the extension associated with the current incoming communication.

18. The computer program product of claim 17 further comprising:
computer readable program code for determining a set of characteristics associated with the current incoming communication in response to determining that an extension is not associated with the current incoming communication.

19. The computer program product of claim 18 further comprising:
computer readable program code for determining whether the set of characteristics associated with the current incoming communication corresponds to a profile in the plurality of profiles; and
computer readable program code for routing the current incoming communication to a profile in the plurality of profiles that corresponds to the set of characteristics associated with the current incoming communication in response to determining that the set of characteristics associated with the current incoming communication does correspond to the profile in the plurality of profiles.

20. The computer program product of claim 19 further comprising:
computer readable program code for routing the current incoming communication to a profile in the plurality of profiles designated as a default profile in response to determining that the set of characteristics associated with the current incoming communication does not correspond to a profile in the plurality of profiles.
